(19) United States
(12) Patent Application Publication
(10) Pub. No.: US 2023/0033536 A1
(43) Pub. Date: Feb. 2, 2023

(54) AUTOMATIC PERFORMANCE OF COMPUTER ACTION(S) RESPONSIVE TO SATISFACTION OF MACHINE-LEARNING BASED CONDITION(S)

(71) Applicant: GOOGLE LLC, Mountain View, CA (US)

(72) Inventor: Satheesh Nanniyur, San Ramon, CA (US)

(21) Appl. No.: 17/779,113

(22) PCT Filed: Dec. 13, 2019
(86) PCT No.: PCT/US2019/066290

§ 371 Date: May 23, 2022

(51) Int. Cl. G06N 20/00

(52) U.S. Cl. CPC G06N 20/00

(57) ABSTRACT

Implementations are directed to automatically performing one or more computer actions responsive to satisfaction of one or more machine learning (ML)-based conditions. Some implementations are directed to determining which ML-based condition(s) to render in an automation interface and/or how to render the machine-learning based conditions in the automation interface. Those implementations can result in a reduced quantity of user inputs (or even no user inputs) being needed to define action condition(s) for computer action(s). Those implementations can additionally or alternatively result in a shortened duration of interaction in defining the action condition(s), which can reduce the duration that component(s) of a client device, being used to interact with the interface, are active and/or are active at a higher-powered state.

### BACKGROUND

Various techniques have been proposed for automatic performance of computer actions responsive to satisfaction of rules-based conditions. For example, techniques have been proposed for automatically forwarding emails, that are sent to a first email address, to an additional email address, when one or more rules-based conditions are satisfied. For instance, the rules-based condition(s) can include: that the email is sent from a particular email address, that the email is sent from a particular email domain, that the email subject includes certain term(s), and/or other rules-based condition(s).

Automatic performance of a computer action responsive to satisfaction of rules-based condition(s) can reduce (or eliminate) user input(s) at a client device that would otherwise be needed to perform the computer action. Further, the automatic performance can conserve various client device resources as otherwise providing such user input(s) at the client device would result in a display and/or other component(s) of the client device from being activated and/or in a higher power state.

However, rules-based conditions, standing alone, can present various drawbacks. As one example, rules-based conditions must be manually defined via extensive user inputs, which can require prolonged interaction with a client device and corresponding prolonged usage of various resources of the client device.

As another example, rules-based conditions can often be too narrowly defined, which can lead to under-triggering—or can be too broadly defined, which can lead to over-triggering. Under-triggering can cause the corresponding automatic action(s) to not be performed in numerous situations where they should be performed, resulting in user input(s) (and resulting utilization of client device resources) still needing to be provided in those situations. Over-triggering can cause the corresponding actions to be performed in numerous situations where they shouldn't be performed, resulting in unnecessary usage of computational and/or network resources in those situations.

Moreover, under-triggering and over-triggering can result in manually redefining of the rules-based conditions in an attempt to mitigate the under-triggering or over-triggering. As with defining the rules-based conditions, redefining the rules-based conditions can likewise result in component(s) of the client device being activated and/or in a higher power state for a prolonged duration.

### SUMMARY

Implementations disclosed herein are directed to automatically performing one or more computer actions responsive to satisfaction of one or more machine learning (ML) based conditions (also referred to herein as “ML-based conditions”). An ML-based condition is one that is determined to be satisfied, or not, based on analysis of predicted output (e.g., a probability value, a vector of values) that is generated based on processing of corresponding data using an ML model for the ML-based condition. Various ML-based conditions and corresponding ML models can be generated and utilized. For example, a first ML-based condition can be “electronic communication with action item” and a corresponding first ML model can be used to process features for an electronic communication to generate output that indicates whether the electronic communication “has an action item”. Also, for example, a second ML-based condition can be “electronic communication requiring immediate attention”, and a corresponding second ML model can be used to process features for an electronic communication to generate output that indicates whether the electronic communication “requires immediate attention”. Additional detail on example ML models and training thereof is provided herein.

Some implementations are directed to determining which ML-based condition(s) to render in an automation interface and/or how to render the ML-based conditions in the automation interface. An automation interface is an interface via which user input(s) can be provided to define computer action(s) and action condition(s) (e.g., ML-based condition(s) and optionally rules-based condition(s)) that, when satisfied, result in automatic performance of the computer action(s). An automation interface, as used herein, encompasses a workflow interface. Implementations that determine which ML-based condition(s) to render and/or how to render them, can result in a reduced quantity of user inputs (or even no user inputs) being needed to define action condition(s) for computer action(s). Those implementations can additionally or alternatively result in a shortened duration of interaction in defining the action condition(s), which can reduce the duration that component(s) of a client device, being used to interact with the automation interface, are active and/or are active at a higher-powered state.

Some implementations are additionally or alternatively directed to training a machine learning model, that is used in evaluating whether a ML-based condition has occurred, based on (e.g., based solely on, or fine-tuned based on) training data that is specific to a user and/or that is specific to an organization. Those implementations can mitigate (or eliminate) occurrences of over-triggering and/or under-triggering when the trained machine learning models are utilized in determining whether to perform computer action(s) for the user and/or the organization. Those implementations can additionally or alternatively mitigate the computational and/or network inefficiencies associated with over-triggering and/or under-triggering.

In some of the implementations that are directed to determining which ML-based condition(s) to render in an automation interface and/or how to render them, the determination(s) are made based at least in part on one or more computer actions that have been defined by the user via the automation interface. In other words, different ML-based condition(s) can be rendered in the automation interface for different computer action(s) and/or ML-based condition(s) can be presented differently for different computer action(s).

For example, when only a first computer action has been defined in the automation interface: a first ML-based condition can be presented with content and/or display characteristic(s) that indicate it is more relevant than a second ML-based condition; the first ML-based condition can be preselected, while the second ML-based condition is not; and/or the first ML-based condition can be presented without presentation of the second ML-based condition. On the other hand, when only a second computer action has been defined in the automation interface: the second ML-based condition can be presented with content and/or display characteristic(s) that indicate it is more relevant than the first ML-based condition; the second ML-based condition can be preselected, while the first ML-based condition is not; and/or the second ML-based condition can be presented without presentation of the first ML-based condition.

More generally, ML-based condition(s) that are more likely to be applicable to defined computer action(s) can be presented in a manner in which they can be selected more quickly and/or can be selected with fewer user input(s) (or even no user input). These technical benefits can be especially impactful for ML-based conditions that may be described with semantic descriptors (e.g., “email with action item”) that, absent techniques disclosed herein, can be difficult for users to ascertain their applicability to computer action(s) to be automatically performed. Accordingly, implementations disclosed herein can help guide a user to more relevant ML-based conditions, during user interaction with the automation interface, while optionally still providing the user with ultimate control over the selected ML-based condition(s).

As mentioned above, in determining which ML-based condition(s) to render and/or how to render them, the determination(s) can be based at least in part on one or more computer actions that have been defined by the user via the automation interface. In some of those implementations, the determination(s) are made based on corresponding metric(s) for each of the ML-based condition(s), where each of the metrics is specific to the ML-based condition and to the computer action(s). The metrics for an ML-based condition, for computer action(s), can be determined prior to, or responsive to, selection of the computer action(s).

For example, for each ML-based condition, at least one corresponding metric can be generated based on the automatic computer action(s) defined by the user. For instance, in generating a metric for a given ML-based condition, past occurrences of the computer action(s) can be identified, where the past occurrences are user-initiated and not automatically performed. The past occurrences can be past occurrences by the user or past occurrences of a group of users (e.g., users of an employer of the user, including the user). Corresponding data for each of the past occurrences can each be processed using a given ML model, for the given ML-based condition, to generate a corresponding predicted value based on the corresponding data. The metric for the given ML model can then be determined based on a function of the predicted values. The corresponding metric can then used to determine whether and/or how to present an indication of the ML-based condition. For example, the metrics can be used to present, highlight, or auto-select “good” (based on the metric) ML-based conditions for the action(s) and/or downplay/suppress “bad” (based on the metric) ML-based condition(s).

As one particular example, assume user input(s) are provided, by a user via the automation interface, to define computer actions of: “forward email to jon@exampleurl.com” (e.g., an email address for an administrative assistant for the user); and “move to ‘action items’ folder”. The user input(s) can define the computer action(s) through freeform input and/or selection from preformed computer actions (e.g., from a drop down list, radio buttons, etc.). Further assume ML-based conditions of: (1) “email with action item” (2) “email requiring immediate attention”; (3) “email with customer issue”; and (4) “email with positive sentiment”. Each of the ML-based conditions can include a corresponding trained ML model that is used to process features of an email and generate output that indicates whether the corresponding ML-based condition is satisfied. A subset of past emails (e.g., of the user providing the input and/or other users) can be identified that were both: forwarded to an “administrative assistant” (e.g., to jon@exampleurl.com or to an “administrative assistant” if that relationship is known); and moved to an ‘action items” folder. The emails (e.g., features thereof) can each be processed using the ML-models for the ML-based conditions to determine: that 90% satisfied ML-based condition (1), and less than 10% satisfied ML-based conditions (2)-(4). As a result, ML-based condition (1) can be: presented most prominently as a suggested condition; automatically selected as a condition (with user confirmation required); and/or presented with an indication of the “90%”. Additionally or alternatively, ML-based conditions (2)-(4) can be suppressed or presented less prominently or with an indication they are likely “not good” (e.g., with indications of their respective percentages). As will be understood from the preceding particular example, the metrics will vary for other selected automatic computer action(s)—leading to different recommendations/displays for those other computer action(s). Moreover, the processing to determine the metrics for computer action(s) that are selected can be performed beforehand or can be performed responsive to the selection.

As mentioned above, some implementations are additionally or alternatively directed to training an ML model, for an ML-based condition, based on (e.g., based solely on, or fine-tuned based on) training data that is specific to a user and/or that is specific to an organization. As one example, assume an “electronic communication requiring immediate attention” ML-based condition. A corresponding ML model can be trained for a user by generating positive training instances based on past electronic communications (of a particular type, or of any of multiple types) that were responded to by a user within 1 hour of receipt, and training based on those positive training instances. Additionally or alternatively, the corresponding ML model can be trained for a user by generating negative training instances based on past electronic communications responded to by the user outside of 1 hour of receipt, optionally conditioned on those electronic communications also having been viewed by the user within 1 hour of receipt. Accordingly, the ML-model can be tailored to identify electronic communications that, for the given user, are typically responded to quickly (e.g., within 1 hour of receipt—or other criteria). The corresponding ML model can optionally be one that was pre-trained based on similar training instances based on interactions of additional users. Types of electronic communications include, for example, emails, rich communication services (RCS) messages, short message service (SMS) messages, multimedia messaging service (MIMS) messages, over-the-top (OTT) chat messages, social networking messages, audible communications (e.g., phone calls, voice mails), audio-video communications, calendar invites, etc.

The above description is provided as an overview of only some implementations disclosed herein. Those implementations, and other implementations, are described in additional detail herein.

Various implementations can include a non-transitory computer readable storage medium storing instructions executable by a processor to perform a method such as one or more of the methods described herein. Yet other various implementations can include a system including memory and one or more hardware processors operable to execute instructions, stored in the memory, to perform a method such as one or more of the methods described herein.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1A illustrates an example environment in which implementations disclosed herein can be implemented.

FIG. 1B depicts an example process flow that demonstrates some implementations of how various components of FIG. 1A can interact.

FIGS. 2A, 2B, 2C, and 2D each illustrate an example of an automation interface, with the automation interfaces each being tailored based on corresponding metrics, the corresponding metrics are also illustrated and are each based on corresponding computer action(s) defined via the automation interface.

FIG. 3 depicts a flow chart illustrating an example method according to various implementations disclosed herein.

FIG. 4 depicts a flow chart illustrating another example method according to various implementations disclosed herein.

FIG. 5 schematically depicts an example architecture of a computer system.

### DETAILED DESCRIPTION

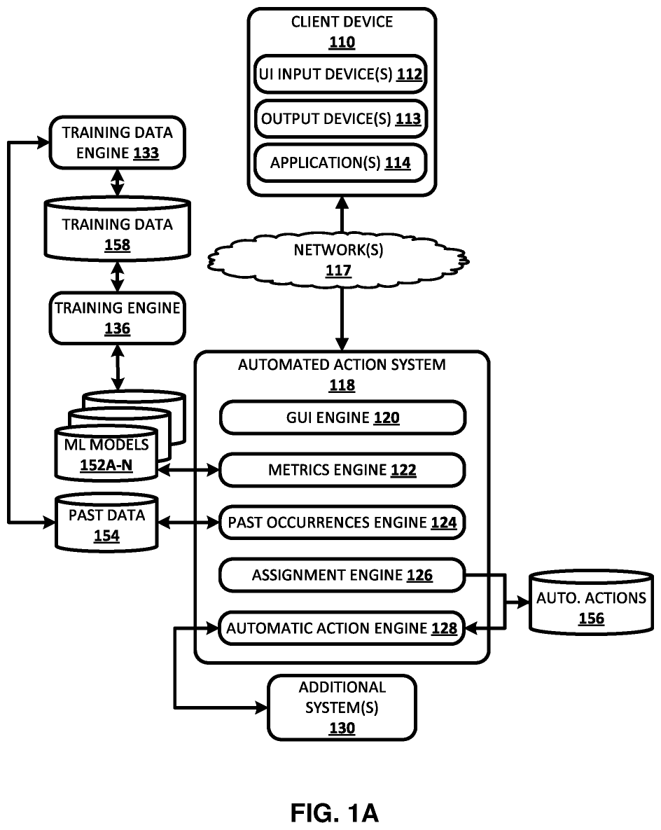

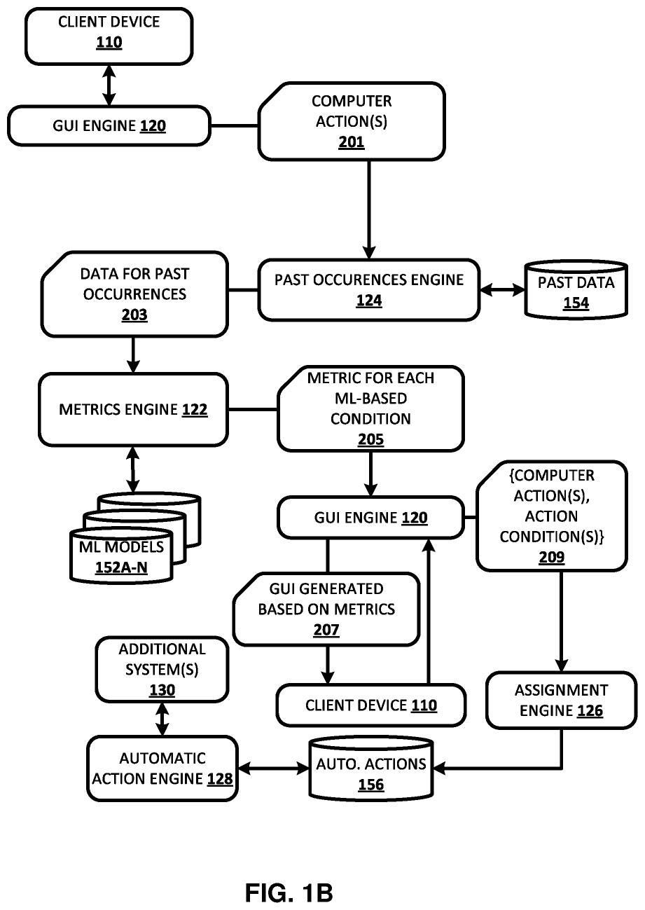

FIG. 1A illustrates an example environment in which implementations disclosed herein can be implemented. The example environment includes a client device 110 and an automated action system 118. Automated action system 118 can be implemented in one or more servers that communicate, for example, through a network (not depicted). Automated action system 118 is one example of a system in which techniques described herein can be implemented and/or with which systems, components, and techniques described herein can interface. Although various components are illustrated and described as being implemented by automated action system 118 in one or more servers that are remote from client device 110, one or more components can additionally or alternatively be implemented (in whole or in part) on client device 110.

A user can interact with automated action system 118 via client device 110. Other computer devices can communicate with automated action system 118, including but not limited to additional client device(s) of the user, additional client devices of other users and/or one or more servers implementing a service that has partnered with the provider of automated action system 118. For brevity, however, the examples are described in the context of client device 110.

Client device 110 is in communication with automated action system 118 through a network such as a local area network (LAN) or wide area network (WAN) such as the Internet (one or more such networks indicated generally at 117). Client device 110 can be, for example, a desktop computing device, a laptop computing device, a tablet computing device, a mobile phone computing device, a computing device of a vehicle of the user (e.g., an in-vehicle communications system, an in-vehicle entertainment system, an in-vehicle navigation system), a standalone interactive speaker (optionally with display) that operates a voice-interactive personal digital assistant (also referred to as an “automated assistant”), or a wearable apparatus of the user that includes a computing device (e.g., a watch of the user having a computing device, glasses of the user having a computing device, a wearable music player). Additional and/or alternative client devices can be provided.

Client device 110 can include various software and/or hardware components. For example, in FIG. 1, client device 110 includes user interface (UI) input device(s) 112 and output device(s) 113. UI input device(s) 112 can include, for example, microphone(s), a touchscreen, a keyboard (physical or virtual), a mouse, and/or other UI input device(s). A user of the client device 110 can utilize one or more of the UI input device(s) 112 to provide inputs to the automation interface described herein. For example, a selection of an element of the automation interface can be responsive to a touch input (via a touchscreen) directed at the element, a mouse or keyboard selection directed at the element, a voice input (detected via microphone(s)) that identifies the element, and/or a gesture input directed at the element (e.g., touch free gesture detected via vision component(s). Output device(s) 113 can include, for example, a touchscreen or other display, speaker(s), and/or other output device(s). A user of the client device 110 can utilize one or more of the output device(s) 113 to consume outputs of the automation interface described herein. For example, a display can be utilized to view visual components of the automation interface and/or the speaker(s) can be utilized to hear audio components of the automation interface. The automation interface can be, for example, visual only, audiovisual, or audio only.

Client device 110 can also execute various software. For example, in the implementation depicted in FIG. 1, client device 110 executes one or more application(s) 114. The application(s) 114 can include, for example, an automated assistant application, a web browser, a messaging application, an email application, a cloud storage application, a videoconferencing application, a calendar application, a chat application, etc. One or more of the application(s) 114 can at least selectively interface with the automated action system 118 in, for example, defining computer action(s) to be automatically performed and defining action condition(s) (e.g., ML-based condition(s) and/or other condition(s)) that, when satisfied, result in automatic performance of the computer action(s). Moreover, the same and/or different application(s) 114 can be utilized to view results of the automatic performance of the computer action(s). For example, a web browser and/or automated assistant application of the application(s) 114 can be utilized in interfacing with the automated action system 118. As another example, the application(s) 114 can include an automated action application that is devoted to interactions with the automated action system 118. As yet another example, the application(s) 114 can include a first application (e.g., an email application) that can interface with the automated action system 118 to define computer actions to be automatically performed that are relevant to the first application, a second application (e.g., a chat application) that can interface with the automated action system 118 to define computer actions to be automatically performed that are relevant to the second application, etc.

Automated action system 118 includes a graphical user interface (GUI) engine 120, a metrics engine 122, a past occurrences engine 124, an assignment engine 126, and an automatic action engine 128.

GUI engine 120 controls an automation interface that is rendered via one of the application(s) 114 of the client device 110. The automation interface is an interface via which user input(s) can be provided (e.g., via one or more of the UI input devices 112) to define computer action(s) and action condition(s) (e.g., ML-based condition(s) and optionally rules-based condition(s)) that, when satisfied, result in automatic performance of the computer action(s). As described herein, in various implementations GUI engine 120 can determine which ML-based condition(s) to render in an automation interface and/or how to render the machine-learning based conditions in the automation interface.

In some of those implementations in which the GUI engine 120 determines which ML-based condition(s) to render in an automation interface and/or how to render them, the determination(s) are made based at least in part on one or more computer actions that have been defined by the user via the automation interface. In other words, the GUI engine 120 can cause different ML-based condition(s) to be rendered in the automation interface for different computer action(s) and/or can cause ML-based condition(s) can be presented differently for different computer action(s). Generally, the GUI engine 120 can cause ML-based condition(s) that are more likely to be applicable to defined computer action(s) to be presented in a manner in which they can be selected more quickly and/or can be selected with fewer user input(s) (or even no user input).

In many implementations where the GUI engine 120 determines which ML-based condition(s) to render and/or how to render them, based at least in part on one or more computer actions that have been defined by the user via the automation interface, the GUI engine 120 makes the determination(s) based on metrics from metrics engine 122.

The metrics engine 122 can interface with the past occurrences engine 124. The past occurrences engine 124 can, for computer action(s) defined via the user interface, identify, from past data database 154, data for past occurrences of the computer action(s). The past occurrences identified by the past occurrences engine 124 are occurrences that are each user-initiated. In other words, the computer actions of the past occurrences are each not automatically performed but, rather, they are performed responsive to one or more manual user inputs. The past occurrences can be past occurrences by the user interfacing with the automation interface or can be past occurrences of a group of users (optionally including the user). The past occurrences can be utilized in techniques described herein contingent on approval from the user(s) that initiated the computer actions of the past occurrences. Where the past occurrences are by a group of users, the group of users can optionally be a group selected based on the users, and the user interacting with the automation interface, all belonging to a common enterprise account of an employer and/or having other feature(s) in common (e.g., all having the same assigned title for the employer, all having the same assigned work group for the employer, etc.). In some implementations, the group of users is selected based on the automation interface being utilized to define a computer action, and associated action condition(s), that are to be applied to all users of the group. For example, the automation interface can include an interface element that enables defining computer action(s) and action condition(s) for either an individual user or for a group of users.

As a working example, if a computer action of “make document available offline” is defined for an automated computer action in a cloud-based storage environment, then the past occurrences engine 124 can identify data for past occurrences of “making a document available offline” in a cloud-based storage environment. Each of the identified past occurrences is performed responsive to user input(s), such as right-clicking the corresponding document in a cloud-based storage interface and selecting “make available offline” in a menu revealed responsive to the right-clicking. The past occurrences engine 124 can identify data for all past occurrences, or for only a subset of past occurrences (e.g., for only 50 occurrences or other threshold quantity). The data of the past data database 154 that is identified can include various features and can depend on the features needed by the metrics engine 122 (described in more detail below). For example, for an action of making a document available offline, features can include features that indicate: a time of creation of the document; a size of the document; a duration of viewing the document; a duration of editing the document; a title of the document (e.g., a Word2Vec or other embedding of the title); image(s) of the document (e.g., embedding(s) of image(s) of the document); terms included in the document (e.g., Word2Vec or other embedding of first sentence(s) of the document)); a folder in which the document is stored; a document type (e.g., PDF, spreadsheet, word processing document); and/or other feature(s).

After the past occurrences engine 124 has identified the data for the past occurrences of the computer action(s), the metrics engine 122 can generate, for each of a plurality of available ML-based conditions that are relevant to the computer action(s), at least one corresponding metric. In some implementations, in generating a metric for an ML-based condition, the metrics engine 122 processes each instance of the data using one of the ML models 152A-N that corresponds to the ML-based condition to generate corresponding predicted output. The metrics engine 122 can then generate the metric for the ML-based condition based on the predicted outputs from the processing using the corresponding ML model. For example, each predicted output can be a probability measure (e.g., from 0 to 1) and the metric can be based on a quantity of the predicted outputs that satisfy a threshold probability measure that indicates the ML-based condition is satisfied (e.g., a threshold probability measure of 0.7, or other probability). For instance, the metric can be a percentage that is based on dividing the quantity of the predicted outputs that satisfy the threshold probability measure by the total quantity of the predicted outputs. Additional and/or alternative metrics can be generated, such as a metric that defines the mean and/or median probability measure of all predicted outputs, and/or that defines a standard deviation of the probability measures of all predicted outputs (optionally excluding outliers).

For example, and continuing with the working example, assume an ML-based condition of “important document” that has a corresponding ML model 152G. The metrics engine 122 can process instances of past data 1-N (individually) using the ML model 152G to generate N separate instances of predicted output that indicate probabilities 1-N. The metrics engine 122 can then generate at least one metric as a function of the probabilities 1-N. The metric generally indicates how often the ML-based condition of “important document” would have been considered satisfied based on the corresponding instances of past data 1-N. Put another way, the metric can provide an indication of how often the ML-based condition would have been considered satisfied in those situations where the user (or a group of users, including the user) manually performed the computer action that has been defined in the automation interface.

The metrics engine 122 can similarly generate metrics for other of the ML-based conditions that are relevant to the computer action, based on processing the instances of past data using other of the ML-based models corresponding to other of the ML-based conditions. For example, the metrics engine 122 can generate metrics for other of the ML-based conditions that relate to cloud-based storage (e.g., those that have the appropriate input parameters corresponding to a cloud-based storage domain). For instance, ML-based conditions can include certain ML-based conditions that correspond only to emails, certain other ML-based conditions that correspond only to documents in cloud-based storage (that can include emails and/or other documents), certain ML-based conditions that correspond to video conferences, and/or certain other ML-based conditions that are applicable to other domains (or even to multiple domains).

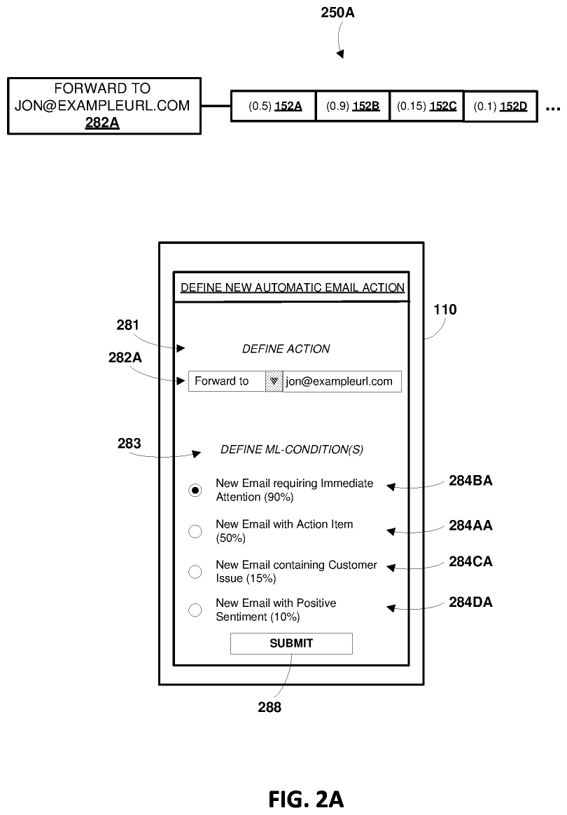

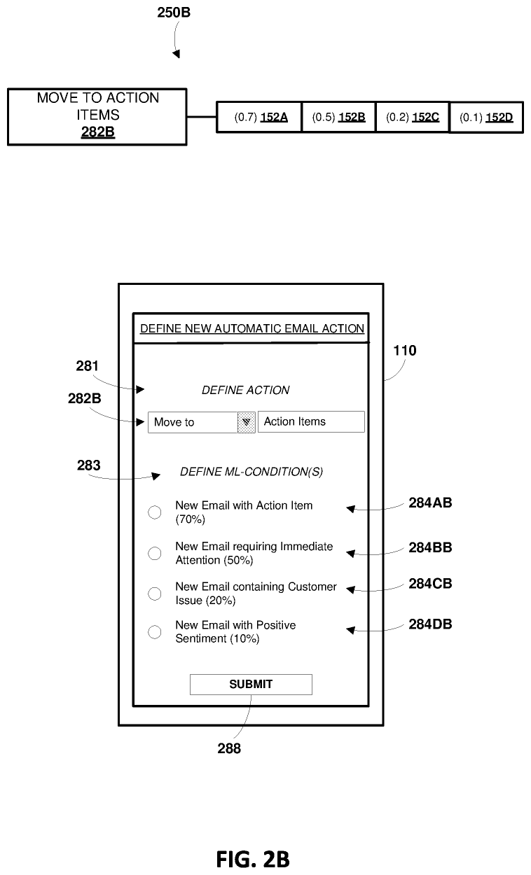

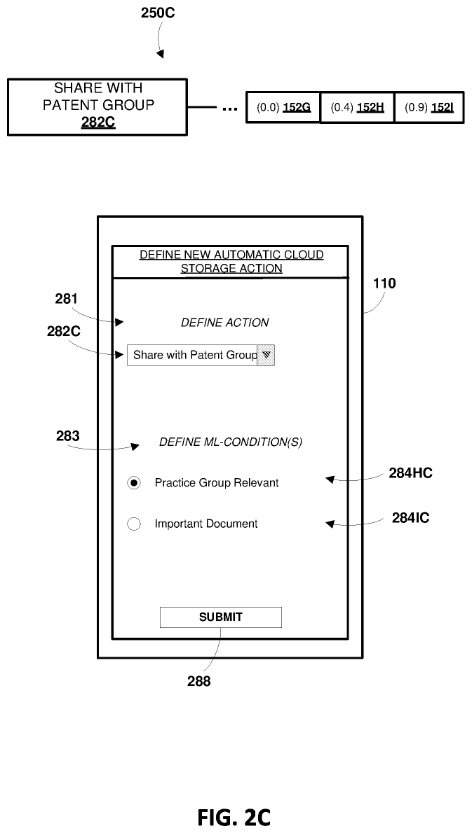

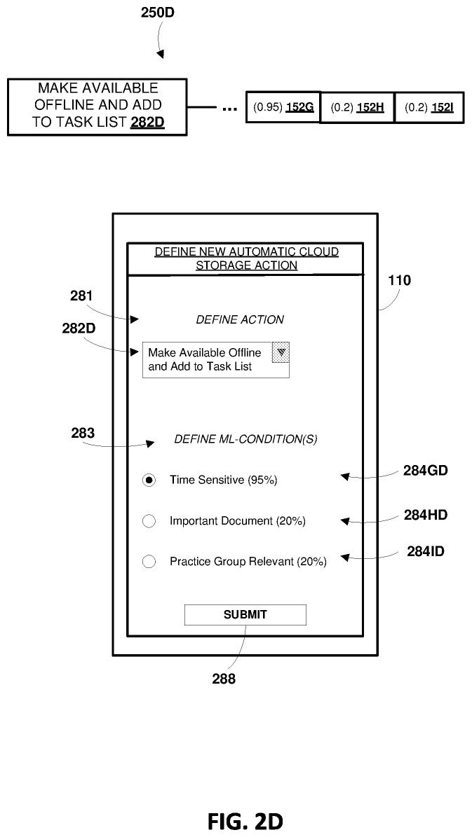

After the metrics engine 122 generates the metrics, the GUI engine 120 can cause ML-based conditions to be rendered (initially, or an updated rendering) in a manner that is dependent on the metrics. For example, the GUI engine 120 can use the metrics to present, highlight, or auto-select “good” (based on the metric) ML-based conditions for the action(s) and/or downplay/suppress “bad” (based on the metric) ML-based condition(s). Also, for example, the GUI engine 120 can additionally or alternatively provide an indication of the metrics along with the ML-based conditions. Some non-limiting examples of automation interfaces that can be rendered by GUI engine 120 based on metrics are illustrated in FIGS. 2A-2D (described below).

A user of the client device 110 can further interact with the automation interface, via one or more UI input devices 112, to select rendered ML-based conditions and/or other action condition(s) (e.g., rules-based or other non-ML-based condition(s)) for the action—and/or to provide confirmatory user input that indicates confirmation of user-selected (and/or automatically pre-selected) condition(s) for the computer action defined via the automation interface. In some implementations, the GUI engine 120 can provide user interface element(s) that enable a user to define, via UI input device(s) 112, multiple conditions. In some of those implementations, the user interface element(s) can optionally enable the user to define, for the multiple conditions, if all need to be satisfied in order to cause automatic performance of the computer action or, instead, if only any subset needs to be satisfied to result in automatic performance of the one or more computer actions. Each subset includes one or more action conditions.

Responsive to a confirmatory user input, the assignment engine 126 can assign, in automatic actions database 156, the computer action(s) to be automatically performed, the action condition(s) for the computer action(s), and an identifier (e.g., account identifier(s)) for the user (or group of users) for whom the computer action(s) are to be automatically performed in response to occurrence of the action condition(s).

After assignment in the automatic actions database 156, the automatic action engine 128 can, with appropriate permission(s) and based on the assignment in the automatic actions database 156, monitor for satisfaction of the condition(s) for the user(s). If the automatic action engine 128 determines satisfaction of the condition(s) for the user(s), it can cause performance of the computer action(s). For example, and continuing with the working example, assume the “important document” ML-based condition was defined for the “make document available offline” computer action. In such a situation, the automatic action engine 128 can process, using the corresponding one of the ML models 152A-N, features of a document of the user(s) and, if the predicted output indicates satisfaction of the ML-based condition, automatically make the document available offline (e.g., cause the document to be downloaded locally to a corresponding client device). The features of the document can be processed, to determine whether the ML-based condition is satisfied, in response to creation of the document, modification of the document, opening of the document, closing of the document, at regular or non-regular intervals, or in response to other condition(s).

In some implementations, the automatic action engine 128 can interface with one or more additional systems 130 in determining whether one or more action condition(s) are satisfied and/or in performing one or more computer actions automatically. For example, for an action of “make my office light blink” that has an ML-based condition of “urgent email”, the automatic action engine 128 can interface with one of the additional system(s) that controls the “office light” to make it blink responsive to determining the ML-based condition is satisfied.

Turning briefly to FIG. 1B, an example process flow is illustrated that demonstrates some implementations of how the client device 110 and various components of the automated action system 118 can interact in various implementations.

In FIG. 1B, the client device 110 is used to interact with an automation interface rendered by GUI engine 120 to define one or more computer action(s) 201. The computer action(s) 201 are provided to past occurrences engine 124. As a working example, the computer action(s) 201 can be for a videoconferencing domain and can be “save transcript of video conference”.

Past occurrences engine 124 interfaces with past data database 154, to identify data for past occurrences 203. The data for past occurrences 203 includes instances of past data, where each instance corresponds to a user-initiated occurrence of the computer action(s) 201. Continuing with the working example, the data for past occurrences 203 can include instances of each occurrence of a user-initiated “saving of a transcript of a videoconference” (e.g., responsive to manual selection of a “save transcript” interface element at the conclusion of the videoconference). Each instance of data can include various features such as features indicative of: a day of the week of the videoconference, a time of day of the videoconference, a duration of the videoconference, topic(s) discussed in the videoconference (as determined from the transcript and/or an agenda), a name for the videoconference, and/or other feature(s). The data for past occurrences 203 is provided to the metrics engine 122.

The metrics engine 122 can then process the instances of data using the ML models 152A-N that correspond to ML-based conditions that are relevant to the videoconference domain. Based on the predictions generated for each of the relevant ML models 152A-N, the metrics engine 122 generates at least one metric for each ML-based condition 205.

The GUI engine 120 can then render (initially, or an updated rendering), a GUI that is generated based on the metrics 207 (i.e., generated based on the metrics of 205). For example, the GUI 207 can omit ML-based condition(s) having poor metric(s), render ML-based condition(s) having good metric(s) more prominently than others having worse metric(s), and/or pre-select ML-based condition(s) having good metric(s). The GUI 207 is rendered in the automation interface and the user can interact with the automation interface, via client device 110, to select action condition(s), modify pre-selected action condition(s), and/or confirm selected (automatically or manually) action condition(s).

Once the selected action condition(s) are confirmed, the GUI engine 120 can provide, to the assignment engine 126, the computer action(s) and the action condition(s) 209. The assignment engine 126 stores, in automatic actions database 156, an entry that includes the computer action(s) and the action condition(s) 209, and optionally an identifier of the user account(s) for which the computer action(s) and the action condition(s) 209 are being defined.

The automatic action engine 128 can, based on the assignment in the automatic actions database 156, monitor for satisfaction of the action condition(s) and, if satisfaction is determined, cause performance of the computer action(s). For example, and continuing with the working example, the automatic action engine 128 can process features of subsequent videoconferences of the user using an ML model for an ML-based condition of the action condition(s). If the processing generates predicted output that satisfies a threshold, the automatic action engine 128 can determine the ML-based condition is satisfied and, as a result, automatically store a transcript of the videoconference. In some implementations, the automatic action engine 128 interfaces with one or more additional systems 130 in determining whether one or more action condition(s) are satisfied and/or in performing one or more computer action(s) automatically.

The determination of the data for past occurrences 203 and the generation of the metric for each ML-based condition 205 are illustrated in FIG. 1B as being performed responsive to user input defining the computer actions 201. However, in various implementations, the data for past occurrences 203 and/or the metric for each ML-based condition 205 can be determined prior to the user input defining the computer actions 201 (i.e., preemptively). In those implementations, various metrics can be pre-generated for various computer actions, and can each optionally be particular to a user or group of users (e.g., organization). Accordingly, in those implementations the GUI generated based on metrics 207 can be rendered more quickly responsive to the user input defining the computer actions 201.

Turning again to FIG. 1A, a training data engine 133, a training data database 158, and a training engine 136 are also illustrated.

The training data engine 133 generates training instances, for inclusion in training data database 158, for training of the ML models 152A-N. It is understood that each of the training instances will be particular for only a single one of the ML models 152A-N. The training data engine 133 generates the training instances for training of the ML models 152A-N and/or for fine-tuning/personalization (to a user or group of users) of one or more of the ML models 152A-N.

In some implementations, and with permission from associated users, the training data engine 133 automatically generates training data based on instances of past data from past data database 154. As an example, assume one of the ML models 152C is being trained (or fine-tuned) to predict whether an email satisfies the ML-based condition of “email requiring immediate attention”. For such an ML-based condition, the training data engine 133 can generate positive training instances based on identifying past data that corresponds to past emails responded to by a user within 1 hour of receipt. For example, each training instance can include training instance input that includes features of such an email and training instance output of a positive label (e.g., a “1”). Additionally or alternatively, for such an ML-based condition, the training data engine 133 can generate negative training instances based on identifying past data that corresponds to past emails responded to by the user outside of 1 hour of receipt, optionally conditioned on those emails also having been viewed by the user within 1 hour of receipt. For example, each training instance can include training instance input that includes features of such an email and training instance output of a negative label (e.g., a “0”). Training data database 158 can additionally or alternatively include training instances that are labeled based on human review.

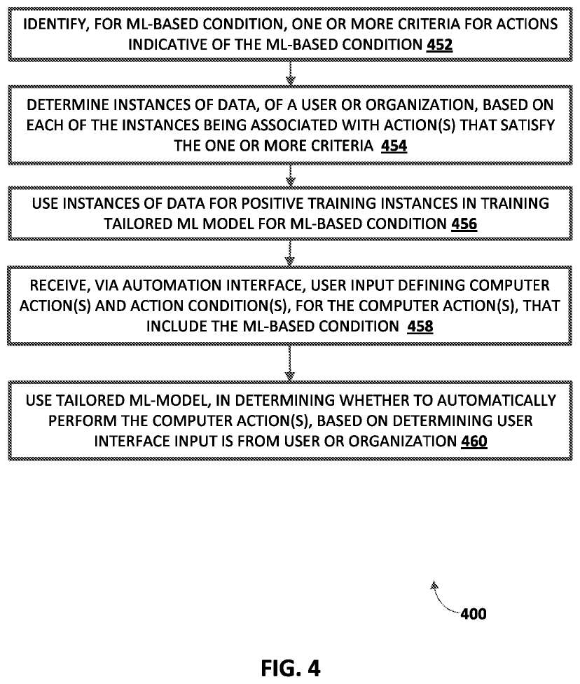

The training engine 136 utilizes the training instances of training data database 158, in training the ML models 152A-N. For example, the training engine 136 can utilize the training instances corresponding to ML model 152A in training ML model 152A, can utilize the training instance corresponding to ML model 152B in training ML model 152B, etc. As described herein (e.g., FIG. 4), in some implementations the training engine 136 can train an ML model, for a user or an organization, based on training instances that are specific to the user or organization. For example, the training data engine 133 can automatically generate training instances, for the ML model, using past data 154 that is for the user or the organization. In some of those implementations, the ML model can be one that was pre-trained based on similar training instances based on interactions of additional users, and the training for the user or the organization can occur after the pre-training. In other implementation, the ML model can be trained based solely on training instances that are specific to the user or the organization. The training engine 136 can store the ML model, trained for the user or the organization, with an identifier that indicates the user or the organization. The identifier can then be utilized to process corresponding data, using the ML model trained for the user or organization, in lieu of other models for the same ML-based condition that are instead trained globally, or for other user(s) or organization(s).

Turning now to FIGS. 2A, 2B, 2C, and 2D, examples of the client device 110 rendering different automation interfaces are illustrated. Each of the automation interfaces are based on corresponding metrics, and each of the corresponding metrics are also illustrated (above the illustrations of the client device 110) and are each based on corresponding computer action(s) defined via the automation interface.

Turning initially to FIG. 2A, a user has interacted with a define action portion 281 of the automation interface to define an action of “forward to jon@exampleurl.com” as an automatic email action. In the example interface of FIG. 2A, the user has selected “forward to” from a drop down menu that includes preambles to various email related actions such as “move to”, “reply with”, “send notification to”, etc. The user has further provided, e.g., via a virtual keyboard, the email address “jon@exampleurl.com”.

The past occurrences engine 124 (FIG. 1) can be used to identify past data for user-initiated actions (e.g., initiated by the user interfacing with the client device 110) of forwarding a corresponding email to “jon@exampleurl.com”. Further, the metrics engine 122 (FIG. 1) can generate, based on the past data, metrics 250A that are illustrated above the client device 110 in FIG. 2A. By being generated based on the past data for the action 282A, the metrics 250A are specific to the action 282A. The metrics 250A include: a metric of 0.5 for ML model 152A (corresponding to ML-based condition “new email with action item”); a metric of 0.9 for ML model 152B (corresponding to ML-based condition “new email requiring immediate attention”); a metric of 0.1 for ML model 152C (corresponding to ML-based condition “new email containing customer issue”); and a metric of 0.1 for ML model 152D (corresponding to ML-based condition “new email with positive sentiment”). The metrics each indicate what percentage of the past emails, that were forwarded to “jon@exampleurl.com”, would have been considered to satisfy the corresponding ML-based condition.

Based on the metrics 250A, the ML-based condition(s) defining portion 283 is generated to include indication 284BA of ML-based condition “new email requiring immediate attention” most prominently (positionally at the “top” of the ML-based conditions) based on it having the “best metric” (0.9) and to pre-select the indication 284BA based on it having a metric that satisfies a threshold (e.g., greater than 0.85). Further, based on the metrics, the portion 283 is generated to include indication 284AA of ML-based condition “new email with action item” positioned next most prominently based on it having the “second best metric” (0.5). Yet further, based on the metrics, the portion 283 is generated to include indication 284CA of ML-based condition “new email containing customer issue” positioned next most prominently based on it having the “third best metric” (0.15). Finally, based on the metrics, the portion 283 is generated to include indication 284DA of ML-based condition “new email with positive sentiment” positioned least prominently based on it having the “worst metric” (0.1). Also illustrated with each of the indications 284BA, 284AA, 284CA, and 284DA is an indication of their metrics (90%, 50%, 15%, and 10%).

A user can, if satisfied with the preselection of indication 284BA, define the ML-based condition of “new email requiring immediate attention” for the action 282A with a single selection of the submit interface element 288. The single selection can be, for example: a touch input that is detected at a touchscreen of the client device 110 and that is directed at the submit interface element 288; a voice input that is detected via microphone(s) of the client device and identifies the submit interface element 288 (e.g., voice input of “submit”, “select the submit button”, or “done”); a selection of the submit interface element 288 via a mouse paired with the client device 110, or a touch-free gesture directed at the submit interface element 288 and detected via a radar sensor or camera sensor of the client device 110. Accordingly, in such a situation the ML-based condition is defined without any user input. Rather, only a confirmatory input is needed to select the submit interface element 288, which results in the action 282A and the ML-based condition of “new email requiring immediate attention” being defined. Alternatively, the user can interact with the automation interface to define additional or alternative ML-based condition(s) or even non-ML-based condition(s) (not illustrated for simplicity). The interactions with the automation interface can be through one or more of any of a variety of input modalities such as touch, voice, gesture, keyboard, mouse, and/or other input modality.

Turning next to FIG. 2B, a user has interacted with the define action portion 281 of the automation interface to define an action of “move to action items” as an automatic email action. In the example interface of FIG. 2B, the user has selected “move to” from a drop down menu that includes preambles to various email related actions and has further provided, e.g., via a virtual keyboard, the location of “action items” (e.g., a virtual folder location).

The past occurrences engine 124 (FIG. 1) can be used to identify past data for user-initiated actions (e.g., initiated by the user interfacing with the client device 110) of moving a corresponding email to “action items”. Further, the metrics engine 122 (FIG. 1) can generate, based on the past data, metrics 250B that are illustrated above the client device 110 in FIG. 2B. By being generated based on the past data for the action 282B, the metrics 250B are specific to the action 282B. The metrics 250B include: a metric of 0.7 for ML model 152A (corresponding to ML-based condition “new email with action item”); a metric of 0.5 for ML model 152B (corresponding to ML-based condition “new email requiring immediate attention”); a metric of 0.2 for ML model 152C (corresponding to ML-based condition “new email containing customer issue”); and a metric of 0.1 for ML model 152D (corresponding to ML-based condition “new email with positive sentiment”). The metrics each indicate what percentage of the past emails, that were moved to “action items”, would have been considered to satisfy the corresponding ML-based condition.

Based on the metrics 250B, the ML-based condition(s) defining portion 283 is generated to include indication 284AB of ML-based condition “new email with action item” most prominently (positionally at the “top” of the ML-based conditions) based on it having the “best metric” (0.7). However, in the example of FIG. 2B, the indication 284BA is not pre-selected on it having a metric (0.7) that fails to satisfy a threshold (e.g., greater than 0.85). Further, based on the metrics, the portion 283 is generated to include indication 284BB of ML-based condition “new email requiring immediate attention” positioned next most prominently based on it having the “second best metric” (0.5). Yet further, based on the metrics, the portion 283 is generated to include indication 284CB of ML-based condition “new email containing customer issue” positioned next most prominently based on it having the “third best metric” (0.2). Finally, based on the metrics, the portion 283 is generated to include indication 284DB of ML-based condition “new email with positive sentiment” positioned least prominently based on it having the “worst metric” (0.1). Also illustrated with each of the indications 284AB, 284BB, 284CB, and 284DB is an indication of their metrics (70%, 50%, 20%, and 10%).

A user can interact with the automation interface to define ML-based condition(s) or even non-ML-based condition(s) (not illustrated for simplicity).

Turning next to FIG. 2C, a user has interacted with the define action portion 281 of the automation interface to define an action of “share with patent group” as an automatic cloud-storage action. The “share with patent group” action, when automatically performed, causes a corresponding document stored in cloud storage to be automatically shared with user accounts assigned to the “patent group” (thereby making it viewable and/or editable by those user accounts). In the example interface of FIG. 2C, the user has selected the action from a drop down menu that includes various cloud-storage related actions.

The past occurrences engine 124 (FIG. 1) can be used to identify past data for user-initiated actions (e.g., initiated by the user interfacing with the client device 110) of sharing a corresponding document with the “patent group”. Further, the metrics engine 122 (FIG. 1) can generate, based on the past data, metrics 282C that are illustrated above the client device 110 in FIG. 2C. By being generated based on the past data for the action 282C, the metrics 250C are specific to the action 282C. The metrics 250C include: a metric of 0.0 for ML model 152G (corresponding to ML-based condition “time sensitive”); a metric of 0.4 for ML model 152H (corresponding to ML-based condition “important document”); and a metric of 0.9 for ML model 152I (corresponding to ML-based condition “practice group relevant”). The metrics each indicate what percentage of the past documents, that were shared with the “patent group”, would have been considered to satisfy the corresponding ML-based condition.

Based on the metrics 250C, the ML-based condition(s) defining portion 283 is generated to include indication 284HC of ML-based condition “practice group relevant” most prominently based on it having the “best metric” (0.9). Further, in the example of FIG. 2C, the indication 284HC is pre-selected based on it having a metric (0.9) that satisfies a pre-selection threshold. Further, based on the metrics, the portion 283 is generated to include indication 284IC of ML-based condition “important document” positioned next most prominently based on it having the “second best metric” (0.4). Yet further, based on the metrics, the portion 283 is generated to omit any indication of ML-based condition “time sensitive” based on it having a metric (0.0) that fails to satisfy a display threshold (e.g., a threshold of 0.1).

A user can, if satisfied with the preselection of indication 284HC, define the ML-based condition of “new email requiring immediate attention” for the action 282C with a single selection of the submit interface element 288. Alternatively, the user can interact with the automation interface to define additional or alternative ML-based condition(s) or even non-ML-based condition(s) (not illustrated for simplicity).

Turning next to FIG. 2D, a user has interacted with the define action portion 281 of the automation interface to define actions of “make available offline” and “add to task list” as automatic cloud-storage actions. Those actions, when automatically performed, cause a corresponding document stored in cloud storage to be available offline (e.g., downloaded locally to a client device) and cause information related to the document (e.g., a title and a link) to be added to a task list (e.g., in a separate application). In the example interface of FIG. 2D, the user has selected the actions from a drop down menu that includes various cloud-storage related actions.

The past occurrences engine 124 (FIG. 1) can be used to identify past data for user-initiated actions (e.g., initiated by the user interfacing with the client device 110) of making a document available offline and adding it to a task list. Further, the metrics engine 122 (FIG. 1) can generate, based on the past data, metrics 282D that are illustrated above the client device 110 in FIG. 2D. By being generated based on the past data for the actions 282D, the metrics 250D are specific to the actions 282D. The metrics 250D include: a metric of 0.95 for ML model 152G (corresponding to ML-based condition “time sensitive”); a metric of 0.2 for ML model 152H (corresponding to ML-based condition “important document”); and a metric of 0.3 for ML model 152I (corresponding to ML-based condition “practice group relevant”). The metrics each indicate what percentage of the past documents, that were both “made available offline” and “added to a task list”, would have been considered to satisfy the corresponding ML-based condition.

Based on the metrics 250D, the ML-based condition(s) defining portion 283 is generated to include indication 284GD of ML-based condition “practice group relevant” most prominently based on it having the “best metric” (0.95). Further, in the example of FIG. 2D, the indication 284GD is pre-selected based on it having a metric (0.95) that satisfies a pre-selection threshold. Further, based on the metrics, the portion 283 is generated to include indication 284HD and 284ID, of ML-based conditions “important document” and “practice group relevant” positioned less prominently based on them having worse metrics (0.2) and without pre-selection based on their metrics failing to satisfy a pre-selection threshold.

A user can, if satisfied with the preselection of indication 284GD, define the ML-based condition of “new email requiring immediate attention” for the actions 282D with a single selection of the submit interface element 288. Alternatively, the user can interact with the automation interface to define additional or alternative ML-based condition(s) or even non-ML-based condition(s) (not illustrated for simplicity).

FIGS. 2A-2D illustrate particular ML-based conditions and computer actions. However, those figures are provided as examples only, and it is understood that techniques disclosed herein can be utilized in combination with a variety of ML-based conditions and/or computer actions. As one example, an ML-based condition of “new calendar event indicating customer meeting” can result in computer action(s) of “add a 24 hour reminder before calendar event” and “schedule one hour on my calendar to prepare for the event”. As another example, an ML-based condition of “chat message, email, or voicemail with potential new client” can include computer action(s) of “add electronic reminder of ‘respond to potential new client’” and “add contact information to CRM”.

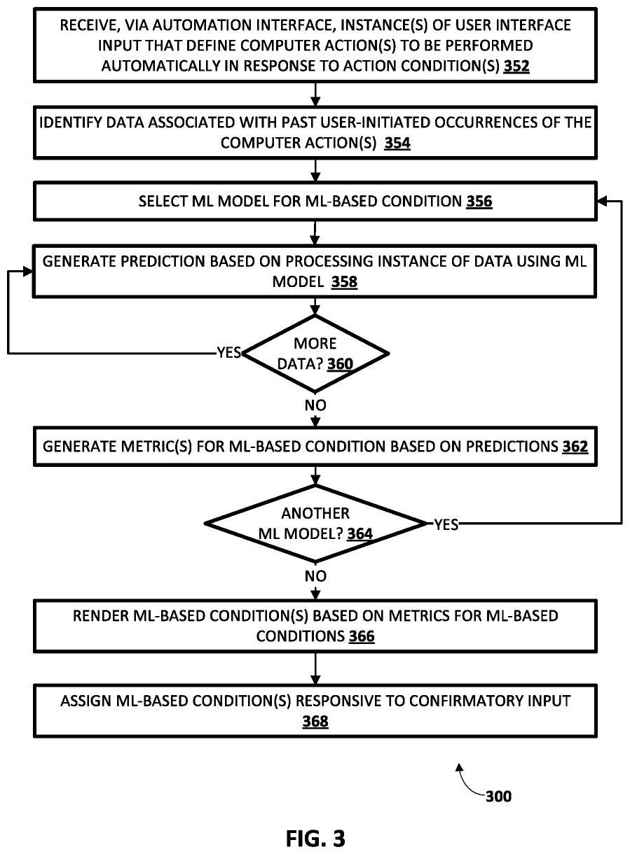

Referring now to FIG. 3, an example method 300 for implementing selected aspects of the present disclosure is described. For convenience, the operations of the flow chart are described with reference to a system that performs the operations. This system may include various components of various computer systems. For instance, operations may be performed at the client device 110 and/or at the automated action system 118. Moreover, while operations of method 300 are shown in a particular order, this is not meant to be limiting. One or more operations may be reordered, omitted or added.

At block 352, the system receives, via an automation interface, one or more instances of user interface input that define one or more computer actions to be performed automatically in response to one or more action conditions. For example, the system can receive the user interface input instance(s) via user interaction with an automation interface.

At block 354, the system identifies data associated with past user-initiated occurrences of the computer action(s). For example, the system can identify data associated with past user-initiated occurrences of the computer action(s) that were initiated by the user that provided the user interface input of block 352 and/or that were initiated by a group of which the user is a member. As another example, the system can identify data associated with past user-initiated occurrences of the computer action(s) that were initiated by various users of a population of users, that may not have any particular relation to the user.

At block 356, the system selects an ML model for an ML-based condition, of the action condition(s). For example, the system can select an ML model based on it being for an ML-based condition that is relevant to the computer action(s) defined in block 352 (e.g., shares a domain with the computer action(s)).

At block 358, the system generates a prediction based on processing an instance of the data (from block 354) using the ML model (from block 356) for the ML-based condition. For example, the system can generate a prediction that indicates (directly or indirectly) a probability that the instance of the data would satisfy the ML-based condition represented by the ML model.

At block 360, the system determines if there is more data to be processed. If so, the system returns to block 358 and generates another prediction based on another instance of the data. If not, the system proceeds to block 362.

At block 362 the system generates one or more metrics, for the ML-based condition, based on the predictions of iterations of block 358 that were performed using the ML model for the ML-based condition. For example, the system can generate a metric as a function of generated probabilities, when the predictions are probabilities.

At block 364, the system determines if there is another ML model, that is relevant to the computer action(s) defined in block 352, and that has not yet been used in iteration(s) of block 358. If so, the system proceeds back to block 356 and selects an additional ML model, then performs blocks 358, 360, and 362 based on the additional ML model. If, not, the system proceeds to block 366.

At block 366, the system renders ML-based condition(s) based on the metrics, for the ML-based conditions, that are determined in iterations of block 362. For example, the system can use the metrics to present, highlight, or auto-select “good” (based on the metric) ML-based conditions for the computer action(s) and/or downplay/suppress “bad” (based on the metric) ML-based condition(s). Also, for example, the system can additionally or alternatively provide an indication of the metrics along with the ML-based conditions.

At block 368, the system assigns ML-based condition(s), to the computer action(s) of block 352, responsive to confirmatory input received at the automation interface. The ML-based condition(s) can be those that are selected (based on user input or pre-selected without modification) when the confirmatory input is received. Non-ML-based condition(s) (e.g., rules-based) can additionally or alternatively be defined via the automation interface and assigned if so. The assignment of the ML-based condition(s), to the computer action(s) of block 352, can be specific to a user or organization and, after assignment, can result in automatic performance of the computer actions responsive to satisfaction of the ML-based condition(s).

Although blocks 354, 356, 358, 360, 362, and 364 are illustrated between blocks 352 and 366, in various implementations those blocks can be performed prior to blocks 352 and 366. For example, those blocks can be performed for a computer action based on past data from a plurality of users to generate corresponding metrics prior to occurrence of block 352. Then, responsive to block 352, the system can proceed directly to block 366 and use the corresponding metrics in performing block 366.

Referring now to FIG. 4, another example method 400 for implementing selected aspects of the present disclosure is described. For convenience, the operations of the flow chart are described with reference to a system that performs the operations. This system may include various components of various computer systems. For instance, operations may be performed at the client device 110 and/or at the automated action system 118. Moreover, while operations of method 300 are shown in a particular order, this is not meant to be limiting. One or more operations may be reordered, omitted or added.

At block 452, the system identifies, for an ML-based condition, one or more criteria for actions indicative of the ML-based condition. For example, if the ML-based condition is “email requiring immediate attention”, the one or more criteria can include responding to an email within 1 hour (or other threshold) of receipt of the email. Also, for example, if the ML-based condition is “important document”, the one or more criteria can include interacting with (e.g., viewing and/or editing) the document at least a threshold quantity of times (optionally over a time duration).

At block 454, the system determines instances of data, of a user or organization, based on each of the instances being associated with action(s) that satisfy the one or more criteria. For example, if the one or more criteria include responding to an email within 1 hour (or other threshold) of receipt of the email, each instance of data can include features of a corresponding email that was responded to within 1 hour. Also, for example, if the one or more criteria include interacting with a document at least a threshold quantity of times, each instance of data can include features of a corresponding document that was interacted with at least a threshold quantity of times.

At block 456, the system uses the instances of data for positive training instances in training a tailored ML model for the ML-based condition. For example, the system can utilize the features of the instances of data as input of the positive training instances, and can assign a positive label as the output of the positive training instances. The system can further train the tailored ML model based on the positive training instance. The tailored ML model can optionally be one that, prior to the training of block 456, was pre-trained based on other training instances that includes those that are not based on instances of data from the user or the organization.

At block 458, the system receives, via an automation interface, user input defining computer action(s) and action condition(s), for the computer action(s), where the action condition(s) include the ML-based condition. For example, the user input can be provided via an automation interface described herein.

At block 460, the system uses the tailored ML-model in determining whether to automatically perform the computer action(s). The system uses the tailored ML model based on determining the user interface input, of block 458, is from the user or the organization. Put another way, the system uses the tailored ML model in determining whether the ML-based condition is satisfied, based on the user interface input of block 458 being from the user or organization and based on the tailored ML model being tailored based on user or organization specific training instances. The system can automatically perform the computer action(s) responsive to determining the ML-based condition is satisfied (and optionally based on one or more other action conditions being satisfied).

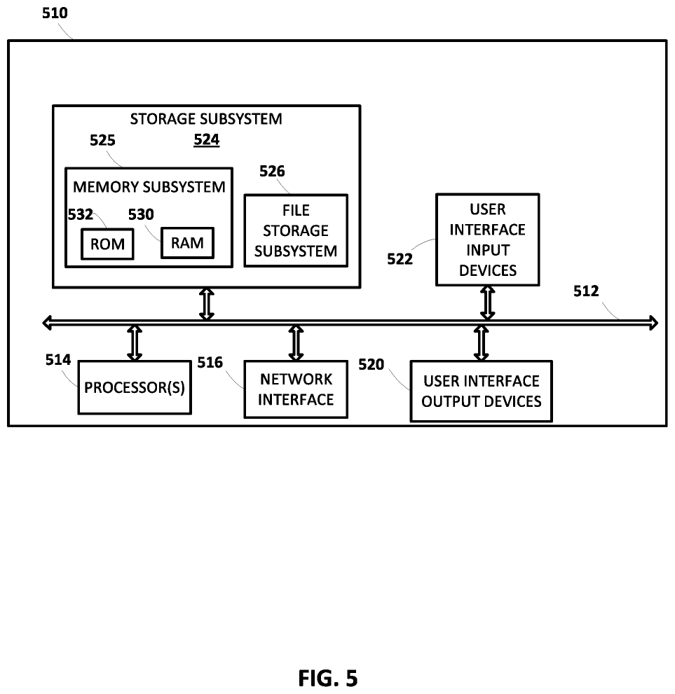

FIG. 5 is a block diagram of an example computer system 510. Computer system 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computer system 510. Network interface subsystem 516 provides an interface to outside networks and is coupled to corresponding interface devices in other computer systems.

User interface input devices 522 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 510 to the user or to another machine or computer system.

Storage subsystem 524 stores programming and data constructs that provide the functionality of some or all of the modules described herein. For example, the storage subsystem 524 may include the logic to perform selected aspects of methods described herein.

These software modules are generally executed by processor 514 alone or in combination with other processors. Memory 525 used in the storage subsystem can include a number of memories including a main random access memory (RAM) 530 for storage of instructions and data during program execution and a read only memory (ROM) 532 in which fixed instructions are stored. A file storage subsystem 524 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 524 in the storage subsystem 524, or in other machines accessible by the processor(s) 514.

Bus subsystem 512 provides a mechanism for letting the various components and subsystems of computer system 510 communicate with each other as intended. Although bus subsystem 512 is shown schematically as a single bus, alternative implementations of the bus subsystem may use multiple busses.

Computer system 510 can be of varying types including a workstation, server, computing cluster, blade server, server farm, or any other data processing system or computing device. Due to the ever-changing nature of computers and networks, the description of computer system 510 depicted in FIG. 5 is intended only as a specific example for purposes of illustrating some implementations. Many other configurations of computer system 510 are possible having more or fewer components than the computer system depicted in FIG. 5.

In situations in which the systems described herein collect personal information about users, or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method is provided that includes receiving instance(s) of user interface input directed to an automation interface, where the instance(s) of user interface input define one or more computer actions to be performed automatically in response to satisfaction of one or more action conditions to be defined via the automation interface. The method further includes identifying corresponding data associated with a plurality of past occurrences of the one or more computer actions. The plurality of past occurrences can optionally be user-initiated and non-automatically performed. The method further includes generating, based on the corresponding data, a corresponding metric for each of a plurality of machine-learning based conditions. The corresponding metrics each indicate how often a corresponding one of the plurality of machine-learning based conditions would have been considered satisfied based on the corresponding data. The method further includes causing an identifier of a given machine-learning based condition, of the plurality of machine-learning based conditions, to be rendered at the automation interface. Causing the identifier of the given machine-learning based condition to be rendered is based on the corresponding metric for the given machine-learning based condition, and/or content and/or display characteristics of the identifier are based on the corresponding metric for the given machine-learning based condition. The method further includes, responsive to receiving further user interface input that confirms assignment of the given machine-learning based condition to the one or more computer actions: assigning, in one or more computer-readable media, the given machine-learning based condition as one of the action conditions.

These and other implementations of the technology disclosed herein can optionally include one or more of the following features.

In some implementations, the content of the identifier is based on the corresponding metric, and the content includes a visual display of the corresponding metric.

In some implementations, the display characteristics of the identifier are based on the corresponding metric, and the display characteristics include a size of the identifier and/or a position of the identifier in the automation interface.

In some implementations, causing the identifier of the given machine-learning based condition to be rendered is based on the corresponding metric, for the given machine-learning based condition, satisfying a display threshold.

In some implementations, the method further includes preventing any identifier of an additional machine-learning based condition, of the plurality of machine-learning based conditions, from being rendered at the automation interface, wherein the preventing is based on the corresponding metric for the additional machine-learning based condition. For example, the preventing can be based on the corresponding metric failing to satisfy a display threshold and/or failing to satisfy a threshold relative to metrics for other machine-learning based conditions (e.g., only N machine-learning based conditions with the best metrics may be rendered).

In some implementations, the method further includes causing, based on the corresponding metric for the given machine-learning based condition, the identifier of the given machine-learning based condition to be pre-selected, in the automation interface, as one of the action conditions. In some of those implementations, the further user interface input that confirms assignment of the given machine-learning based condition to the one or more computer actions is a selection of an additional interface element that occurs without other user interface input that alters the pre-selection of the given machine-learning based condition. Causing the identifier of the given machine-learning based condition to be pre-selected can be based on the corresponding metric satisfying a pre-selection threshold and/or satisfying a threshold relative to metrics for other machine-learning based conditions (e.g., based on it being the best of all metrics).

In some implementations, generating, based on the corresponding data, the corresponding metric for the given machine-learning based condition includes: processing the corresponding data, using a given machine-learning model for the machine-learning based condition, to generate a plurality of corresponding values; and generating the metric based on the plurality of corresponding values. In some of those implementations, the plurality of corresponding values are probabilities, and generating the metric includes generating the metric as a function of the probabilities.

In some implementations, the method further includes receiving additional user interface input that defines one or more rules-based conditions and, in response to the further user interface input, assigning, in one or more computer-readable media, the one or more rules-based conditions as additional of the action conditions whose satisfaction results in automatic performance of the one or more computer actions. In those implementations, the further user interface input that confirms assignment of the given machine-learning based condition to the one or more computer actions, also confirms assignment of the one or more rules-based conditions. In some versions of those implementations, the one or more rules-based conditions and the given machine-learning based condition are assigned as both needing to be satisfied to result in automatic performance of the one or more computer actions. In some other versions of those implementations, the given machine-learning based condition, if satisfied standing alone, results in automatic performance of the one or more computer actions.

In some implementations, identifying the corresponding data includes identifying the corresponding data based on it being for a user that provided the user interface input, or being for an organization of which the user is a verified member.

In some implementations, the one or more actions include modifying corresponding content, transmitting the corresponding content to one or more recipients that are in addition to the user, and/or causing a push notification of the corresponding content to be presented to the user. In some versions of those implementations, the corresponding content is a corresponding electronic communication. For example, the corresponding electronic communication can be an email, a chat message, or a voicemail (e.g., a transcription thereof). In some additional or alternative versions, the method further includes, subsequent to assigning the given machine-learning based condition as one of the action conditions: receiving given content of the corresponding content; determining that the given machine-learning based condition is satisfied; and automatically performing the one or more actions based on determining that the given machine-learning based condition is satisfied. Determining that the given machine-learning based condition is satisfied can include processing features, of the given content, using a given machine-learning model for the given machine-learning based condition, to generate a value, and determining that the given machine-learning based condition is satisfied based on the value.

In some implementations, identifying the corresponding data associated with the plurality of past occurrences of the one or more computer actions, and generating the corresponding metrics based on the corresponding data, both occur prior to receiving the one or more instance of user interface input.

In some implementations a method is provided that includes: identifying, for a given machine-learning based condition, one or more criteria for actions that are indicative of the machine-learning based condition; determining corresponding instances of data, of a user or organization, based on each of the instances of data being associated with one or more corresponding computer actions that satisfy the one or more criteria; and using the corresponding instances of data, and a positive label, as positive training instances in training a tailored machine-learning model, for the machine-learning based condition, that is specific to the user or the organization. The method further includes, subsequent to training the tailored machine-learning model: (1) receiving one or more instances of user interface input directed to an automation interface, where the one or more instances of user interface input define one or more computer actions to be performed automatically in response to satisfaction of one or more action conditions, and one or more action conditions, including the machine-learning based condition; and (2) based on the one or more instances of user interface input being from the user or an additional user of the organization, and based on the machine-learning based condition being included in the defined one or more action conditions: using the tailored machine-learning model in determining whether the one or more action conditions are satisfied in determining whether to automatically perform the one or more computer actions.

These and other implementations of the technology disclosed herein can optionally include one or more of the following features.

In some implementations, the method further includes, prior to receiving the one or more instances of user interface input: identifying, for the given machine-learning based condition, one or more negative criteria for actions that are not indicative of the machine-learning based condition; determining corresponding instances of negative data, of the user or the organization, based on each of the instances of data being associated with one or more corresponding computer actions that satisfy the one or more negative criteria; and using the corresponding instances of negative data, and a negative label, as negative training instances in training the tailored machine-learning model.

In some implementations, the one or more criteria include responding to an electronic communication within a threshold duration of time.

In some implementations, a method is provided that includes receiving one or more instances of user interface input directed to an automation interface. The one or more instances of user interface input define one or more computer actions to be performed automatically in response to satisfaction of one or more action conditions to be defined via the automation interface. The method further includes causing an identifier of a given machine-learning based condition, of a plurality of machine-learning based conditions, to be rendered at the automation interface. Causing the identifier of the given machine-learning based condition to be rendered is based on the one or more computer actions, and/or content and/or display characteristics of the identifier are based on the one or more computer actions. The method further includes, responsive to receiving further user interface input that confirms assignment of the given machine-learning based condition to the one or more computer actions: assigning, in one or more computer-readable media, the given machine-learning based condition as one of the action conditions.

These and other implementations of the technology disclosed herein can optionally include one or more of the following features.

In some implementations, the method further includes identifying corresponding data associated with a plurality of past occurrences of the one or more computer actions; and generating, based on the corresponding data, a corresponding metric for each of the machine-learning based conditions. In those implementations, causing the identifier of the given machine-learning based condition to be rendered based on the one or more computer actions is based on the corresponding metric for the given machine-learning based condition and/or the content and/or the display characteristics of the identifier are based on the one or more computer actions based on the content and/or the display characteristics being based on the corresponding metric for the given machine-learning based condition. In some of those implementations, the past occurrences are user-initiated and non-automatically performed and/or the corresponding metrics each indicate how often a corresponding one of the plurality of machine-learning based conditions would have been considered satisfied based on the corresponding data.

In some implementations, the identifier of the given machine-leaning based condition was initially rendered at the automation interface with initial content and/or display characteristics prior to receiving the one or more instances of user interface input defining the one or more computer actions. In some of those implementations, causing the identifier to be rendered includes causing the identifier to be rendered with the content and/or display characteristics, and the content and/or display characteristics differ from the initial content and/or display characteristics.

1. A method implemented by one or more processors, the method comprising:
receiving one or more instances of user interface input directed to an automation interface, the one or more instances of user interface input defining one or more computer actions to be performed automatically in response to satisfaction of one or more action conditions to be defined via the automation interface;
identifying corresponding data associated with a plurality of past occurrences of the one or more computer actions;
generating, based on the corresponding data, a corresponding metric for each of a plurality of machine-learning based conditions, wherein the corresponding metrics each indicate how often a corresponding one of the plurality of machine-learning based conditions would have been considered satisfied based on the corresponding data;
causing an identifier of a given machine-learning based condition, of the plurality of machine-learning based conditions, to be rendered at the automation interface,
wherein causing the identifier of the given machine-learning based condition to be rendered is based on the corresponding metric for the given machine-learning based condition, and/or
wherein content and/or display characteristics of the identifier are based on the corresponding metric for the given machine-learning based condition;
responsive to receiving further user interface input that confirms assignment of the given machine-learning based condition to the one or more computer actions:
assigning, in one or more computer-readable media, the given machine-learning based condition as one of the action conditions.

2. The method of claim 1, wherein the content of the identifier is based on the corresponding metric, and wherein the content comprises a visual display of the corresponding metric.

3. The method of claim 1, wherein the display characteristics of the identifier are based on the corresponding metric, and wherein the display characteristics comprise a size of the identifier and/or a position of the identifier in the automation interface.

4. The method of claim 1, wherein causing the identifier of the given machine-learning based condition to be rendered is based on the corresponding metric, for the given machine-learning based condition, satisfying a display threshold.

5. The method of claim 1, further comprising:
preventing any identifier of an additional machine-learning based condition, of the plurality of machine-learning based conditions, from being rendered at the automation interface, wherein the preventing is based on the corresponding metric, for the additional machine-learning based condition, failing to satisfy a display threshold.

6. The method of claim 1, further comprising:
causing, based on the corresponding metric for the given machine-learning based condition satisfying a pre-selection threshold, the identifier of the given machine-learning based condition to be pre-selected, in the automation interface, as one of the action conditions;
wherein the further user interface input that confirms assignment of the given machine-learning based condition to the one or more computer actions is a selection of an additional interface element that occurs without other user interface input that alters the pre-selection of the given machine-learning based condition.

7. The method of claim 1, wherein generating, based on the corresponding data, the corresponding metric for the given machine-learning based condition comprises:
processing the corresponding data, using a given machine-learning model for the machine-learning based condition, to generate a plurality of corresponding values; and
generating the metric based on the plurality of corresponding values.

8. The method of claim 7, wherein the plurality of corresponding values are probabilities, and wherein generating the metric comprises generating the metric as a function of the probabilities.

9. The method of claim 1, further comprising:
receiving additional user interface input that defines one or more rules-based conditions;
wherein the further user interface input that confirms assignment of the given machine-learning based condition to the one or more computer actions, and confirms assignment of the one or more rules-based conditions; and
further comprising, in response to the further user interface input:
assigning, in one or more computer-readable media, the one or more rules-based conditions as additional of the action conditions whose satisfaction results in automatic performance of the one or more computer actions.

10. The method of claim 9, wherein the one or more rules-based conditions and the given machine-learning based condition are assigned as both needing to be satisfied to result in automatic performance of the one or more computer actions.

11. The method of claim 9, wherein the given machine-learning based condition, if satisfied standing alone, results in automatic performance of the one or more computer actions.

12. The method of claim 1, wherein identifying the corresponding data comprises identifying the corresponding data based on it being for a user that provided the user interface input, or being for an organization of which the user is a verified member.

13. The method claim 1 wherein the one or more actions comprise:
modifying corresponding content, transmitting the corresponding content to one or more recipients that are in addition to the user, and/or causing a push notification of the corresponding content to be presented to the user.

14. The method of claim 13, wherein the corresponding content is a corresponding electronic communication.

15. The method of claim 13, further comprising, subsequent to assigning the given machine-learning based condition as one of the action conditions:
receiving given content of the corresponding content;
determining that the given machine-learning based condition is satisfied, wherein determining that the given machine-learning based condition is satisfied comprises:
processing features, of the given content, using a given machine-learning model for the given machine-learning based condition, to generate a value, and
determining that the given machine-learning based condition is satisfied based on the value; and
automatically performing the one or more actions based on determining that the given machine-learning based condition is satisfied.

16. The method of claim 1, wherein identifying the corresponding data associated with the plurality of past occurrences of the one or more computer actions, and generating the corresponding metrics based on the corresponding data, both occur prior to receiving the one or more instance of user interface input.

17. A method implemented by one or more processors, the method comprising:
identifying, for a given machine-learning based condition, one or more criteria for actions that are indicative of the machine-learning based condition;
determining corresponding instances of data, of a user or organization, based on each of the instances of data being associated with one or more corresponding computer actions that satisfy the one or more criteria;
using the corresponding instances of data, and a positive label, as positive training instances in training a tailored machine-learning model, for the machine-learning based condition, that is specific to the user or the organization;
receiving one or more instances of user interface input directed to an automation interface, the one or more instances of user interface input defining:
one or more computer actions to be performed automatically in response to satisfaction of one or more action conditions, and
one or more action conditions, including the machine-learning based condition;
based on the one or more instances of user interface input being from the user or an additional user of the organization, and based on the machine-learning based condition being included in the defined one or more action conditions:
using the tailored machine-learning model in determining whether the one or more action conditions are satisfied in determining whether to automatically perform the one or more computer actions.

18. The method of claim 17, further comprising, prior to receiving the one or more instances of user interface input:
identifying, for the given machine-learning based condition, one or more negative criteria for actions that are not indicative of the machine-learning based condition;
determining corresponding instances of negative data, of the user or the organization, based on each of the instances of data being associated with one or more corresponding computer actions that satisfy the one or more negative criteria;
using the corresponding instances of negative data, and a negative label, as negative training instances in training the tailored machine-learning model.

19. The method of claim 17, wherein the one or more criteria comprise responding to an electronic communication within a threshold duration of time.

20. A method implemented by one or more processors, the method comprising:
receiving one or more instances of user interface input directed to an automation interface, the one or more instances of user interface input defining one or more computer actions to be performed automatically in response to satisfaction of one or more action conditions to be defined via the automation interface;
causing an identifier of a given machine-learning based condition, of a plurality of machine-learning based conditions, to be rendered at the automation interface,
wherein causing the identifier of the given machine-learning based condition to be rendered is based on the one or more computer actions, and/or
wherein content and/or display characteristics of the identifier are based on the one or more computer actions;
responsive to receiving further user interface input that confirms assignment of the given machine-learning based condition to the one or more computer actions:
assigning, in one or more computer-readable media, the given machine-learning based condition as one of the action conditions.

21-26. (canceled)
